(19) United States
(12) Patent Application Publication
(10) Pub. No.: US 2012/0114810 A1
(43) Pub. Date: May 10, 2012

(54) FLEXIBLE SACHET AND MANUFACTURING METHOD

(75) Inventor: Gilles Demaurex, Cugy (CH)

(73) Assignee: NESTEC S.A., Vevey (CH)

(21) Appl. No.: 13/382,769

(22) PCT Filed: Jun. 28, 2010
(86) PCT No.: PCT/EP2010/059109

§ 371 Date: Jan. 6, 2012

(30) Foreign Application Priority Data
Jul. 8, 2009 (EP) 09164873.3

(51) Int. Cl. B65D 75/42; A47F 7/16; A23L 2/395; B65D 30/00; B65B 3/02

(52) U.S. Cl. 426/119; 383/37; 53/452; 211/45

(57) ABSTRACT

The present invention relates to triangular closed flexible sachets (100), and methods of manufacturing a triangular closed flexible sachet holding a substance comprises folding upon itself at least a single flexible sheet (200) to form a triangular interior space, filling the triangular interior space with the substance, welding the at least single folded sheet along a plurality of welding lines so as to capture the substance in said interior space, and sealing the closed flexible sachet (100). The invention further relates to methods of folding, displaying and/or storing a chain of sachets and a hanging device for a chain of sachets.

### TECHNICAL FIELD

The invention relates generally to closed sachets, and more particularly, to a closed flexible sachet or chain of closed flexible sachets in the form of individual portion(s) provided for extraction of their content(s) by a user, and to their manufacturing method. The invention further relates to methods of use of said sachet(s) and to display and storing methods of said sachets or chains of sachets.

### BACKGROUND OF THE INVENTION

The invention relates to a closed flexible sachet, or chain of closed flexible sachets, containing at least one substance intended for a plurality of uses. Among others, it is envisioned that the contents of the sachet(s) will be presented as a powder for the preparation of a beverage.

The use of pre-metered and pre-packaged portions of, for example, instant coffee intended for the preparation of coffee beverage has the advantage that it facilitates the coffee preparation operations while ensuring that the quality of the resulting product is relatively consistent.

These portions are currently provided in a variety of forms.

According to a first form, the pre-packaged portions are presented as disclosed in Swiss Patent No. 636 311, U.S. Pat. No. 5,012,629, and European Patent Publication No. 272 432. A sachet is formed by two sheets of filter paper sealed over their periphery and filled with ground coffee. This presentation and solution has the drawback that an additional oxygen-barrier outer packaging is required to be provided to prevent the oxidation of the product during storage, therefore entailing additional manufacturing costs, and at least a supplementary step for the consumer who has to remove the additional packaging before the desired coffee can be extracted.

According to a second form, disclosed for example in U.S. Pat. No. 6,347,725, a closed flexible sachet, comprising a beverage component is formed by at least one flexible sheet sealed along a sealing line around its periphery to define an interior space containing the beverage component, the sheet comprising overlapping edges, and a channel configured for ingress of extraction fluid into the interior space, the channel having an outside channel portion defined between the overlapping edges and extending towards the sealing line on an opposite side from the interior space, wherein the flexible sheet is impermeable to oxygen and to water vapor. The sachet according to U.S. Pat. No. 6,347,725 may be of square, rectangular, oval or other shapes. If the sachet is of rectangular shape, it has a width from about 2 cm to about 15 cm, preferably from about 4 cm to about 6 cm, and a length from about 5 cm to about 30 cm, preferably from about 6 cm to about 20 cm.

According to a third form, disclosed for example in U.S. Pat. No. 7,207,719, packing may be sachets such as flat sachets, sealed edge sachets, cavity sachets, self-supporting cavity sachets or hose sachets or bags such as welded flat or folded bags. Similarly, packing can have at least one sealing seam on a side edge, e.g. a sealing seam such as a hot or cold sealing seam, weld seam or glue seam. Depending on the method of production, flat sachets can for example have three or four sealing seams on three or four side edges, a hose sachet can have an upper and a lower transverse seam or an upper and a lower and a back seam such as an overlapping or folded back seam. Packing units are presented for example polygonal and in particular rectangular in top view. In cross section the packing units can be round or polygonal and in particular rectangular.

All of the above forms suffer from the drawbacks that they require large storing spaces, their convenience and facility of use is not optimal, especially for manual extraction by a user, their use of material for manufacturing is less than optimal. Compared to conventional rectangular shaped sachets, the novel sachet proposed in accordance with the present invention exhibits lower laminate consumption, and reduced sealing area without compromise insofar as the size of the facing towards the consumer, especially when the sachets is displayed as a chain.

### SUMMARY OF THE INVENTION

The present invention solves at least the above enumerated problems by providing a closed sachet or a chain of closed flexible sachets for substance presentation, use, and storage in the form of individual portion(s) provided for extraction of their content(s) by a user, and a respective manufacturing method for said sachets or chain of sachets. The invention further provides methods of use of said sachet(s) and methods of display and storing of said sachets or chains of sachets.

The present invention further relates to a chain of flexible sachets comprising a plurality of closed flexible sachets, the chain of sachets being formed by a plurality of individual triangular closed flexible sachets bonded together at either one of an extremity of each individual sachet or along a welding line.

The present invention further relates to a method of manufacturing a triangular closed flexible sachet holding a substance, comprising folding upon itself at least a single flexible sheet to form a triangular interior space, filling the triangular interior space with the substance, welding the at least single folded sheet along a plurality of welding lines so as to capture the substance in the interior space, and sealing the closed flexible sachet.

The method of manufacturing a triangular closed flexible sachet holding a substance assumes that the plurality of welding lines comprises one of two or three welding lines, and may further comprise sealing two opposed sheets to create a right angle isosceles triangle shaped triangular closed flexible sachet. The plurality of welding lines comprises at least one sealing line along the vertical direction of a filing tube and sealing lines at 45 degree angles versus the vertical direction of the filing tube.

The present invention further yet relates to a method of manual use of a closed flexible sachet by a user in the course of preparing a beverage, comprising tearing the closed flexible sachet along previously designated split lines, holding the teared sachet adjacent to a receptacle, and pouring the contents of the teared sachet in the receptacle where the beverage is prepared, wherein the closed flexible sachet is of triangular shape.

The present invention further provides for a method of storage of a chain of closed flexible sachets of triangular shape, comprising folding upon itself in circular motion the chain of closed flexible sachets, compacting the folded chain of sachets into a parallelepiped shape, and wrapping the compacted sachet chain into a box, for presentation, or outer wrapping, for storage.

The present invention further yet provides for a method of displaying a chain of closed flexible sachets, comprising unwrapping a chain of flexible closed sachets comprising a plurality of triangle shaped individual sachets, unfolding the chain of sachets, hanging the chain of sachets, wherein a hanging device is employed to facilitate hanging, and displaying the chain of flexible sachets.

In the context of the present invention it is envisioned that the individual triangular closed flexible sachet pertains to a chain of sachets, the chain being formed by a plurality of individual closed triangular flexible sachets bonded together either at an extremity of each individual sachet or along a welding line. The closed flexible sachet is a polygonal shape closed flexible sachet. The closed flexible sachet is preferably shaped as a right angle isosceles triangle.

The closed flexible sachet comprises a flexible blank of material made among others of aluminium, polyester, polyethylene, polypropylene, polyamide, polystyrene, paper, copolymer of ethylene and vinyl alcohol, polyvinylidene chloride, polyvinylacetate or mixtures thereof. It is either a single flexible blank of material or a plurality of blanks of material that are provided and folded upon itself/themselves to form the interior space.

The interior space of the closed flexible sachet comprises one or more compartments. The substance comprised in the closed flexible sachet is an individual portion of a powdered beverage and may be selected from the group consisting of ground roast coffee, tea, instant coffee, a mixture of instant coffee and ground coffee, a chocolate product, dehydrated milk, and dehydrated cream. The powdered beverage is present in a weight amount from about 5 g to about 50 g.

The closed flexible sachet is substantially symmetrical about the sealing line, and a plurality of split lines are located at designated corners of its triangular shape.

The plurality of welding lines of said closed flexible sachet holding a substance comprises either one of 2 or 3 welding lines.

Still other objects and advantages of the present invention will become readily apparent to those skilled in the art from the following detailed description, wherein only the preferred embodiment of the invention is shown and described, simply by way of illustration of the best mode contemplated of carrying out the invention. As will be realised by the persons skilled in the art, the invention is capable of other and different embodiments, and its several details are capable of modifications in various obvious aspects, all without departing from the invention.

Accordingly, the drawings and description are to be regarded as illustrative in nature, and not restrictive.

### BRIEF DESCRIPTION OF THE DRAWINGS

FIG. 1A is an overall view of a sachet, proposed in accordance with the present invention;

FIG. 1B is a diagrammatic plan view of a sachet, in accordance with an embodiment of the present invention;

FIG. 1C is a diagrammatic plan view of a sachet, in accordance with another embodiment of the present invention;

FIG. 1D is a diagrammatic plan view of a sachet, in accordance with yet another embodiment of the present invention;

FIG. 1E is a diagrammatic plan view of a sachet, in accordance with yet another embodiment of the present invention;

FIG. 2 are plan views of a blank at different stages of manufacturing a closed triangular sachet according to the invention;

FIG. 3 is a plan view of a triangular closed chain of sachets manufactured in accordance with a method of the present invention, and a section view of the triangular closed chain of sachets;

FIG. 4 is a detailed representation of a sachet chain manufacturing method in accordance with an embodiment of the manufacturing method of the present invention;

FIG. 5 is a further step by step representation of a manufacturing method in accordance with the present invention;

FIG. 6 is a plan view of a triangular closed chain of sachets manufactured in accordance with a method of the present invention, and a section view of the triangular closed chain of sachets;

FIG. 7 is a schematic representation of a sachet chain manufacturing method in accordance with an embodiment of the manufacturing method of the present invention;

FIG. 8 is a schematic representation of a sachet chain manufacturing method, in accordance with an embodiment of the manufacturing method of the present invention;

FIG. 9 is a schematic representation of sachets dissociation from a chain of sachets into individual sachets prior to use; and

FIG. 10 is a view of sachet chain folding according to the method of the invention.

FIG. 11 is an illustration of a chain of sachets on display.

FIG. 12a is a hanging device for storing and/or displaying a chain of sachets.

FIG. 12b is the hanging device shown in FIG. 12a seen from the side.

FIG. 12c is another embodiment of the hanging device for storing and/or displaying a chain of sachets.

FIG. 12d is the hanging device shown in FIG. 12c seen from the side.

FIG. 12e illustrates a chain of sachets hanging on the hanging device of the invention.

FIG. 13 is a view of sachet chain folding according to the method of the invention.

FIGS. 14a and 14b are views of a chain of sachets folded according to the method of the invention.

### DETAILED DESCRIPTION OF THE INVENTION

While the present invention is susceptible of embodiment in many different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated.

The description below, although described in particular to instant coffee, is not limiting and is given by way of example, as the closed flexible sachet of the present invention may be employed to hold other products or mixtures of products such as tea, soluble coffee, chocolate or dehydrated foods adapted to provide drinks or foods in the form of infusions, with a diverse presentation such as liquids, pastes, gels, granules and a variety of other solid items, chemicals, cosmetics, fragrances and personal use items. A person skilled in the art of packaging, reading the present description will envision other alternatives besides the ones enumerated above. The examples given above are not meant to be limiting and are intended to encompass a variety of other substances. It is envisioned that they will be presented as any variation of powder, liquid, paste and solid form.

The sachet presented by the present invention, and manufactured by the implementation of the methods according to the invention, is in one exemplary embodiment of the present invention a sealed flexible bag made from a single sheet of material. The bag may be made by either folding a single sheet along the length, joining the lateral edges and sealing at 45 degree angles, folding a single sheet at 45 degrees over it self, sealing and folding again, and so on, or sealing two opposed sheets to create a right-angled isosceles triangle. At least as such, the material is shaped in order to provide a volume, which makes it possible to contain the substance intended to be stored, the bag being intended to be used as it is in the intended extraction mode and including at least one linear weld. In the following the term bag and the term sachet will be used interchangeably and assigned the same meaning.

By sealed, is meant that the bag is closed and impervious or practically impervious to the substance contained therein. Preferably the bag is also impervious to oxygen and to water vapour, i.e. if the product stored therein is sensitive to degradation by oxygen and/or water. By useable as it is, is meant that such a bag is directly ready for use and requires no prior preparation before manually using it or before putting it into a machine.

Its advantages among others reside in the fact that it provides many functions during the various steps of its use, such as it provides the function of packaging and/or of protecting a metered amount of a substance, e.g. against oxygen or water, during the period of storage.

Its novelty lies at least in its shape, presentation, size, contents, the nature of its materials and the extent to which it is filled, its method of manufacture, its methods of use and its methods of display and storing.

The sachet according to the invention is of polygonal shape in plane view. In particular, the sachet may have at least one of the following shapes: right isosceles type, oblique triangle, acute-angled triangle, obtuse-angled triangle, or any other triangular shape that may be apparent to a person skilled in the art.

The sachet of the invention may have any size suitable for storing the amount of substance desired. In exemplary embodiments of the invention wherein the sachet is of right isosceles type, it is envisioned that its side length may be from about 2 cm to about 20 cm, preferably from about 4 cm to about 6 cm, and its hypotenuse length from about 2.5 cm to about 25 cm. Once filled, the sachet may have a thickness, at its centre of e.g. from about 1 mm to about mm, preferably from about 5 mm to about 10 mm. The measured amount of powdered substance contained may preferably vary from about 1 g to about 100 g, more preferably from about 8 g to about 30 g, according to its use. Should the sachet be employed to comprise a liquid, it is envisioned that it may e.g. hold from 1 cl to 100 cl.

The effective level of filling of the volume of the bag with the envisioned substance may be any suitable level, e.g. between 10 and 70%, though the sachet may also be completely filled. This effective level of filling may be markedly less than the apparent level of filling if the substance contained is itself highly porous and has a large free volume between its particles.

A low effective level of filling of the bag is also envisioned if the bag has a high internal pressure. In the case in which the bag has been vacuum-sealed, the level of filling is much higher.

If the substance comprised in the sachet is prone to oxidize, the manufacturing operations may be performed under the protection of a stream of oxygen-free inert gas, for example under nitrogen.

The blank may consist of sheets or folded sheets made from flexible material such as aluminum with a thickness of from 5 microns to 40 microns, or from plastic such as polyester (PET).

Preferably, the sheets will consist of a flexible, multi-layer material which is suitable for welding using customary methods while at the same time forming sufficient protection for the product against oxygen and water vapour.

The following combination of materials is preferred: outer layer: PET (normal, woven or non-woven), polyethylene (PE), polypropylene (PP), polyamide (PA), polystyrene (PS) or paper having a thickness from about 1 micron to about 20 microns and preferably from about 5 microns to about 15 microns;

high-grade barrier central layer; aluminum, a copolymer of ethylene and vinyl alcohol (EVOH), polyvinylidene (PVDC), PET or polyvinylacetate (PVA) having a thickness from about 3 microns to about 25 microns and preferably from about 5 microns to about 20 microns;

inner layer: plastic, preferably PE or PP or oriented polypropylene (OPP) with welding lacquer and having a thickness from about 1 microns to about 20 microns, and preferably from about 5 microns to about 15 microns. The total thickness of these layers is generally from 5 microns to 40 microns. Alternatively the materials may also comprise monolayer metalized foil or BOPP.

A seal may e.g. be achieved at a temperature of between 180 degrees C. and 250 degree C. Alternatively, sealing may be performed by ultrasonic means, or any other suitable means.

It is e.g. possible to envisage the following multi-layer combinations: PET-EVOH-PE or PET-aluminum-PE. The use of biodegradable or water-soluble material is also possible as a single layer or in combination with other material(s).

As a result of the at least one of the manufacturing procedures envisioned in accordance with the present invention, the laminate consumption to manufacture the sachet is decreased. Further, since at least in one embodiment of the invention is envisioned that the triangle will have only two sealed margins, the need for sealing areas is reduced, therefore as well reducing laminate consumption and energy consumption needed for sealing. Further yet, if the triangular sachet is manufactured in accordance with this folding over itself method, no multilayer sealing is necessary.

In the specific embodiment of a chain of isosceles triangular sachets, due to 45° angle of sealing region a chain of closed flexible sachets in accordance with the present invention may be folded over itself by rotation over itself into a square shape. Therefore, when folded, its dimensions may be optimized, the folded chain being easy to pack in secondary packaging. It becomes possible to dispense the individual closed triangular shape sachets that form the chain from a square box.

Due to their triangular shape, the individual sachets have intuitive opening and their contents is easy to pour. Their opening may be intuitively placed in one of the corners of the triangle, therefore facilitating easiness of pouring their contents, since their contents slides easily towards the outside in the funnel formed at the opening. Further, due to corner opening, the risk of powder or liquid spilling is reduced, and a smaller headspace is required.

Should the chain of closed flexible sachets be available for display, it is noticeable that the chain formed by triangular sachet exhibits larger facing than a chain formed by prior art sachets of rectangular shape.

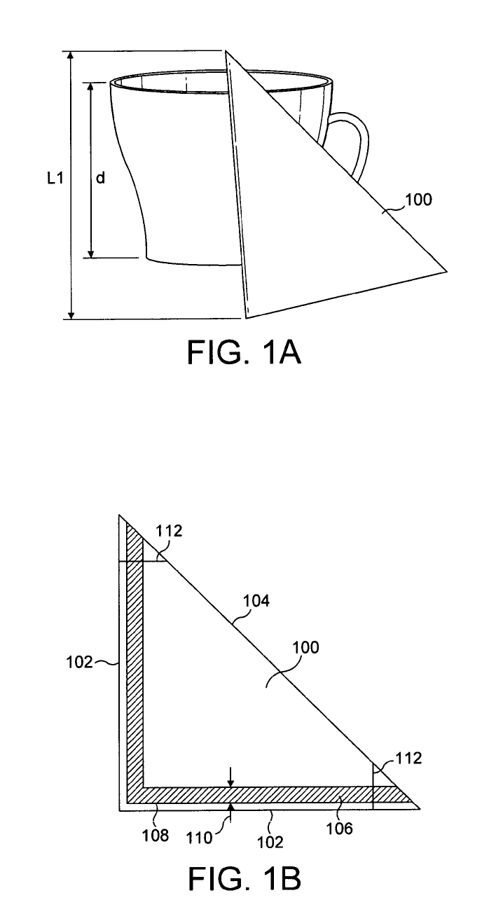

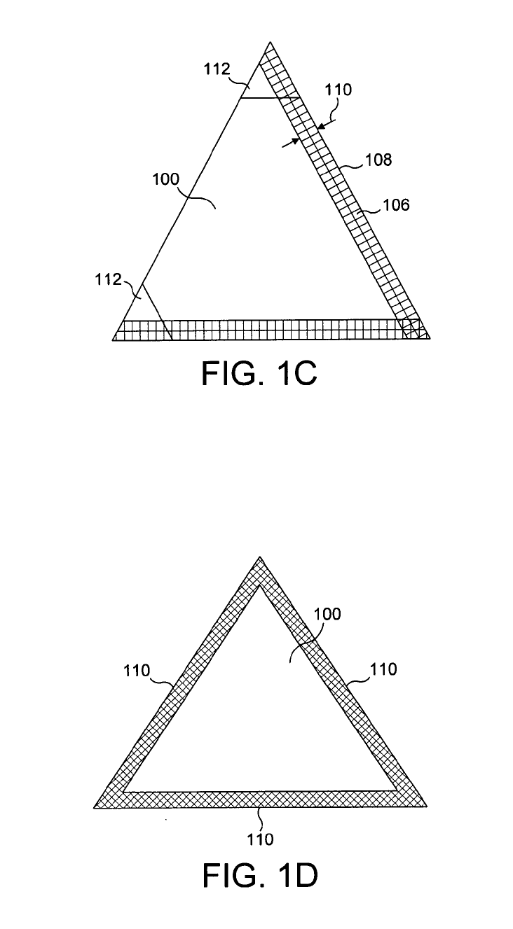

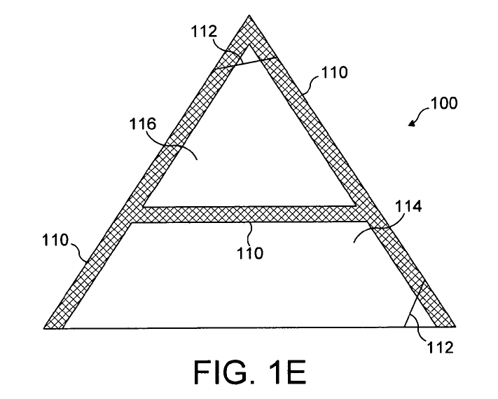

FIG. 1A is an overall view of a sachet, in accordance with the present invention.

In FIG. 1A a sachet 100, implemented in accordance with one embodiment of the present invention, is presented in perspective view versus a cup where its contents are intended to be manually used by a consumer to prepare a beverage.

The sachet 100, presented in FIG. 1A, is only exemplary in nature, especially insofar the logo and other ornamental or functional indicia on the sachet, as well as the presence of said printed indicia both on the face of the sachet facing the user and on the face of the sachet concealed from the user in the present view.

FIG. 1B is a diagrammatic plan view of a sachet, in accordance with an embodiment of the present invention.

The sachet 100 of FIG. 1B is in the shape of a right isosceles triangle with the adjacent and opposite sides 102 of length L1 equal with each other. The hypotenuse of the sachet is indicated with 104 and is of length L2. The sachet may comprise 2 or 3 sealed sides, with the sachet 100 of FIG. 1B illustrating an example with two sealing areas 106. A provision for breaks 108 may as well be present, especially in cases when storage of a larger volume or higher mass of material is envisioned in the sachet. The sachet is provisioned with one or two corner opening splits 112, located at designated split lines, such as two non right interior angle corners of the triangle.

Alternatively, the sachet may e.g. be provided with a splitting filament along the hypotenuse, in the embodiment of the present invention where the sachet is sealed only along two sealing lines. Said embodiment is especially suitable for the cases where it is important that the contents of the sachet are extracted without compromising the shape of its contents, as it may be the case where the sachet comprises individual portions of solid foods.

FIG. 1C is a diagrammatic plan view of a sachet in accordance with another embodiment of the present invention;

The sachet 100 of FIG. 1C is in the shape of a equilateral triangle, with sides 102 equal with each other. Further, the sachet presented FIG. 1C represents the case where only two sides of the triangle are sealed and reinforced.

Various combinations of shape and reinforcement on 2 or 3 sides are envisioned within the scope of the present invention, and the examples provided above are not limiting in this respect. Three side reinforcement may be e.g. envisioned for a sachet used in connection with storage of liquids, heavier or larger contents, etc.

FIG. 1D is a diagrammatic plan view of a sachet, in accordance with yet another embodiment of the present invention;

Sachet 100 represented in FIG. 1D is a closed flexile triangle sachet shaped as right angle isosceles triangle where the sachet comprises one interior compartment enclosed by 3 side welding.

Sachet 100 represented in FIG. 1E is yet another embodiment of the present invention in accordance to which the closed flexile triangle sachet is shaped as right angle isosceles triangle where the sachet comprises two interior compartments one compartment enclosed by 3 side welding and the second compartment having one side without welding and the remaining sides reinforced. Each compartment is envisioned to comprise at least one split line 112 intuitively placed in a corner to facilitate opening for a user. The two compartments may comprise either the same substance or two different substances.

The invention also relates to a method of manufacturing a chain of triangular closed flexible sachet holding a substance, the method comprising folding upon itself a flexible sheet to form a triangular interior space; filling said triangular interior space with the substance; and sealing said at least one folded sheet along a plurality of welding lines so as to capture the substance in said interior space; and repeating the steps above one or more times.

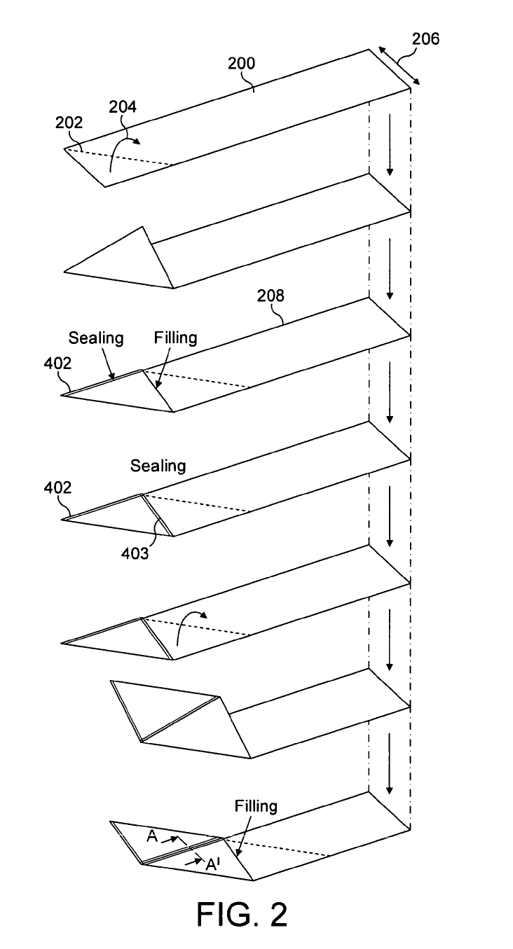

FIG. 2 shows plan views of the blank at different stages of manufacturing the sachet according to one method of the present invention.

In FIG. 2, the blank 200 is a multi-layer flexible sheet which is foldable along the folding line 202 in the folding direction 204 so as to create in it an interior space that may receive the substance to be stored therein.

Assuming that what is meant to be manufactured is the closed flexible right isosceles triangle sachet 100 presented in FIG. 1B, the length of the folding line is equal with the hypotenuse 104 of said triangle. In this case, the width 206 of blank 200 is conveniently elected at the beginning of the manufacturing process so as to accommodate diagonally across a folding line 202 of length equal with the hypotenuse of the desired size of the sachet 100.

The flexible sheet is then folded around itself along the lines 202 disposed at 45 degrees angle in the folding direction 204. Once one side of the triangle has aligned with the margin 208 of the blank 200 and the other side is perpendicular on said margin 208, the folding is accomplished and the desired enclosed right angle triangular shaped interior space is formed.

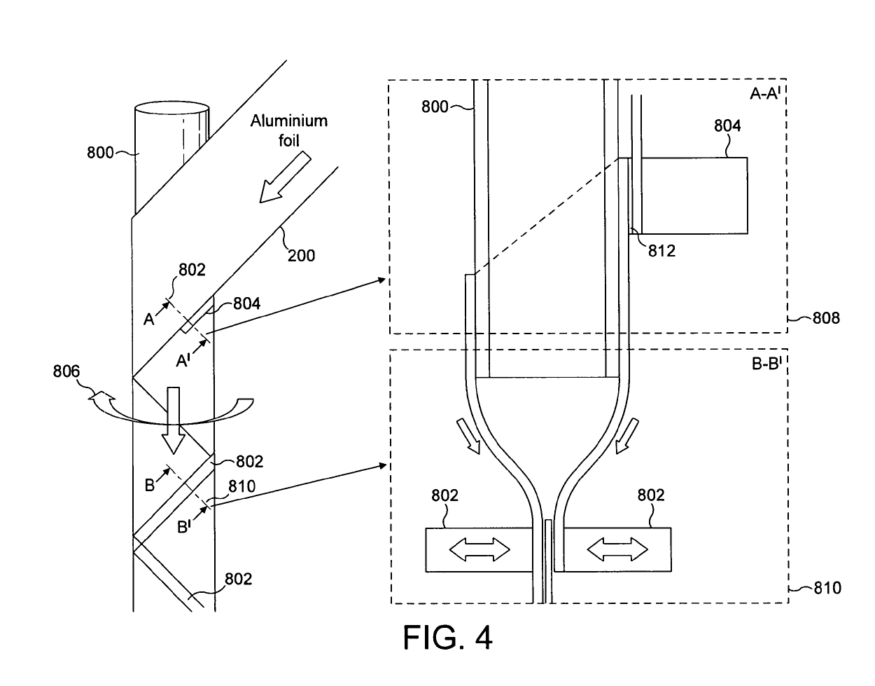

As illustrated in FIG. 4, the interior space once filled with a substance is sealed along lines 402 and 403 to trap its contents inside. The seal along line 402 may conveniently be performed before filling of the interior space.

In the subsequent step, the flexible sheet blank is again folded upon itself at 45 degrees angle to form the next enclosed interior space or volume. The operation is repeated one or more times, as many times as desired, till the desired number of triangular sachets in the chain has been formed, or alternatively the length of the blank sheet has been exhausted.

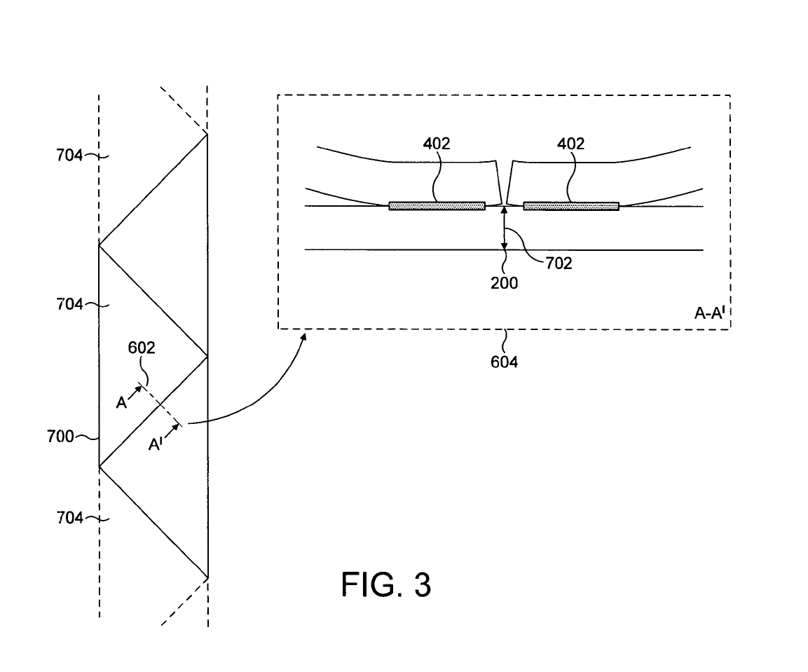

A chain of closed triangular sachets 700 manufactured in accordance with the method of the present invention as it is illustrated in FIG. 2, comprising individual right angle isosceles triangle shaped sachets 704 is illustrated in FIG. 3. A section line 602 (A-A′) traverses the welding line of adjacent individual closed triangular sachets. In section view 604 of said section line 602 is may be observed that the single layer blank 200 that has been overlapped by folding upon itself to form the desired sachet may be sealed by a melted sealing layer 402 that assist to enclose the desired interior space.

A chain of sachets provisioned in accordance with the solution discussed above, where the triangle sachets are linked together by a single layer of blank laminate, allows for a good separation when a user wants to separate one sachet from another, due to the decreased stiffness of the separation area that now may have only one layer and said layer may be as well further weakened, e.g. by perforation.

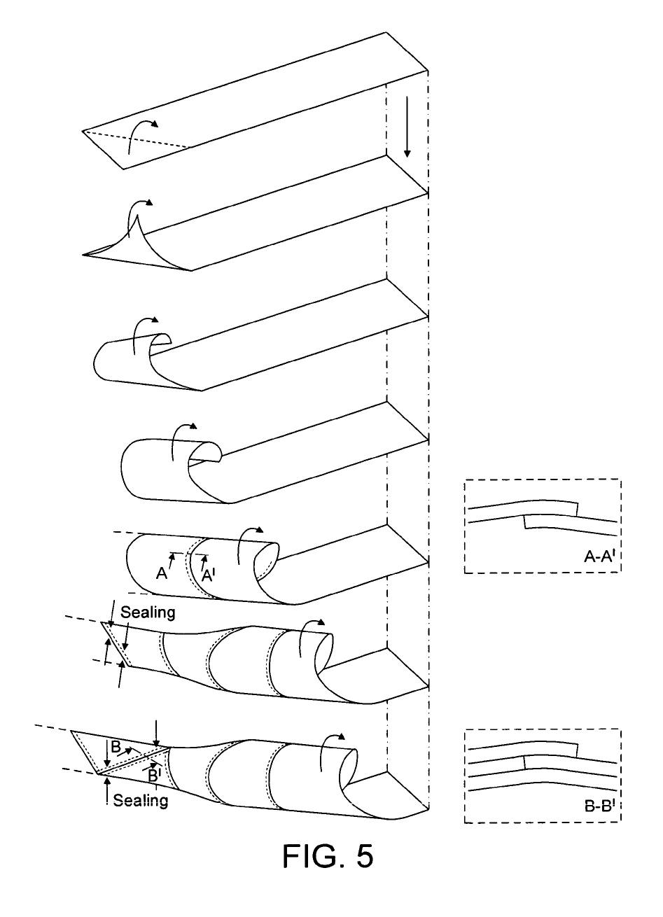

FIGS. 4 and 5 illustrate further embodiments of the manufacturing method of the present invention, wherein a chain of triangular closed flexible sachet holding a substance, is manufactured by a method comprising: rolling a blank sheet of flexible material around itself or around a tube until the margin of the blank is united with the blank itself enclosing a cylindrical volume and creating an overlap of the blank with itself along the margin; joining the two layers of the blank at the overlap by sealing to create a tubular structure; dispensing said substance into the tubular structure; and flattening the tubular structure and joining the already formed sealing to the opposite surface of the flattened tube creating a sealing of three layers enclosing triangular interior spaces enclosing said substance.

In these embodiments a blank sheet of material is rolled upon itself (FIG. 5) or around a tube (FIG. 4) in till the margin of the blank is united with the blank itself enclosing therefore a cylindrical volume of a predetermined circumference. Said rolling of the blank may e.g. be continued till a second complete roll is realized. Between the first roll and the second roll there is a small overlap of material, overlap where the two layers may be joined by sealing, welding or the like, creating a tubular structure. As it may be observed in section view along section line A-A′ an area of two blanks overlap is present along the section line, area that is sealed, e.g. by a melted sealing layer. As it may be observed in section view 808, the blank sheet ingresses into the sachet welding machine under a 45 degree angle and is rolled, e.g. around the filing tube 800 in the direction indicated by the arrow. Upon rolling a sealing of the foil is created at the overlap (812) creating the tubular structure, e.g. around a filling tube. In the embodiment of FIG. 4, a filling tube ingresses into said tubular structure at a depth conveniently elected so the substance intended to be packaged in the sachets may be dispensed.

As it may further be observed in section view 810 the filling tube may dispense in the direction indicated by the arrows the substance intended to be packaged in the sachet, in a space that is delimited by a secondary sealing (802) closing the end of the tube. The secondary sealing is formed by flattening the tubular structure and joining the already formed primary sealing to the opposite surface of the flattened tube creating a sealing of three layers. Following dispensing said substance, the tubular structure comprising the substance will be moved further in the direction of the arrows and a secondarily seal (802) will be formed again, to form a triangular closed sachet. The operation is repeated as many times as desired. As it may be observed in section view along section line B-B′, the secondary seal forms an area of three blanks overlap joined, e.g. by melted sealing layers. As it may be observed, in the embodiment of FIG. 4 the individually formed triangular sachets are filled by a vertical tube through which the contents intended to be comprised by the individual triangular sachets are dispensed, progressively as each of the sachets is formed using the steps described above. The result is a chain of right angle isosceles triangular sachets that are sealed/welded on two sides, with the third side the hypotenuse of said triangle constituting the folding line of the flexible blank, and connected together at the sealed sides.

In the course of forming the right angle isosceles triangle, the sachet may be provided with split lines, e.g. conveniently located in the vicinity of the 45 degree angles, either at only one of said angles or at both to facilitate opening of the sachet. The split line may be machined at the elected position to provide for a weakened tearing line along which a user may manually tear said sachet to gain access to its contents.

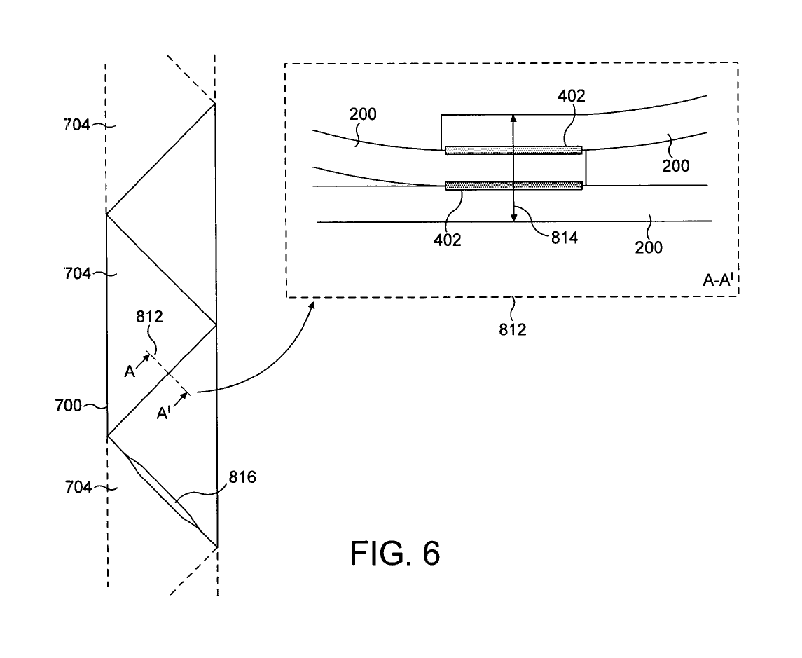

FIG. 6 illustrates a chain of closed triangular sachets 700 manufactured in accordance with the method of the present invention discussed above for the case where the triangle sachets are linked together by 3 layers of laminate, for example as it is illustrated in FIG. 4, comprising individual right angle isosceles triangle shaped sachets 704. A section line 812 (A-A′) traverses the welding line of adjacent individual closed triangular sachets that are united only at their sides. In section view 812 of said section line 812 is may be observed that the single layer blank 200 that has been overlapped by folding upon itself to form the desired sachet is sealed, e.g. by a melted sealing layer 402, that assist to enclose the desired interior space and due to the particularities of folding of the method of manufacturing of the present invention now exhibits 3 overlapping layers of laminate. The blank sheet disposed on top is in contact with the subsequent layer of laminate that is as well sandwiched between another layer that separates it from the lower layer of laminate. Separation line 814 may be conveniently perforated to form opening 816 to facilitate separation of the sachets. Opening 816 is formed between the extremities of triangle sachets, e.g. being of a size that is sufficiently large for allowing the finger of a user to be easily introduced in the opening but not large enough to entirely dissociate one subsequent sachet from another.

A user aiming to dissociate a closed triangular sachet from a chain of sachets where said sachets are linked by three layers of laminate and the chain is provided with an opening 816 may, for example, introduce his finger in the opening and apply downward pressure to further enlarge the opinion and in the process tear the links that unite the sachets at their extremities.

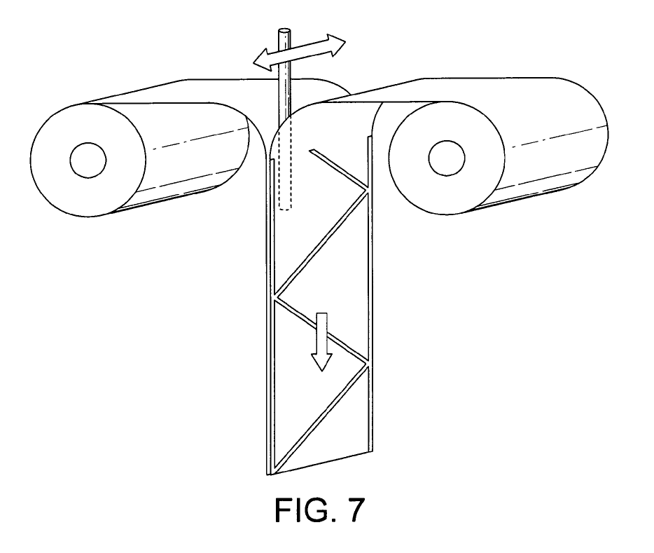

FIG. 7 is a schematic representation of a sachet chain manufacturing method in accordance with a further embodiment of the manufacturing method of the present invention.

A plurality of flexible blanks of material, preferably two of them, are introduced into a packing machine that feeds them into a device comprising preformed means for cutting and welding the blanks of material. Should the moulds be conveniently elected to be of isosceles triangular shape, upon passing through the packing machine, the two blanks are cut into the desired shape and welded together at all three sides, to form a 3 sides sealed right angle isosceles triangular sachet. Since the length and width of the blank accommodates the formation at the same time of a plurality of sachets, said sachets may be dissociated from each other upon curing and welding or they are preserved connected to each other to form a chain of sachets according to the invention.

In accordance with another embodiment of the method proposed by the present invention, the flexible blank sheet is folded symmetrically along its middle and sealed along its overlapping free margins. The resulting tubular blank is filled with the desired substance and welding heads of the desired shape and inclination stamp the tubular blank to form a chain of triangular sachets that are either sachets exhibiting two welded sides and sachets exhibiting three welded sides. The sachets may be preserved in a chain or dissociated in individual sachet either by stamping a weakened line between the individual sachet at the same time or subsequently to the welding time or by cutting them apart at the time of welding.

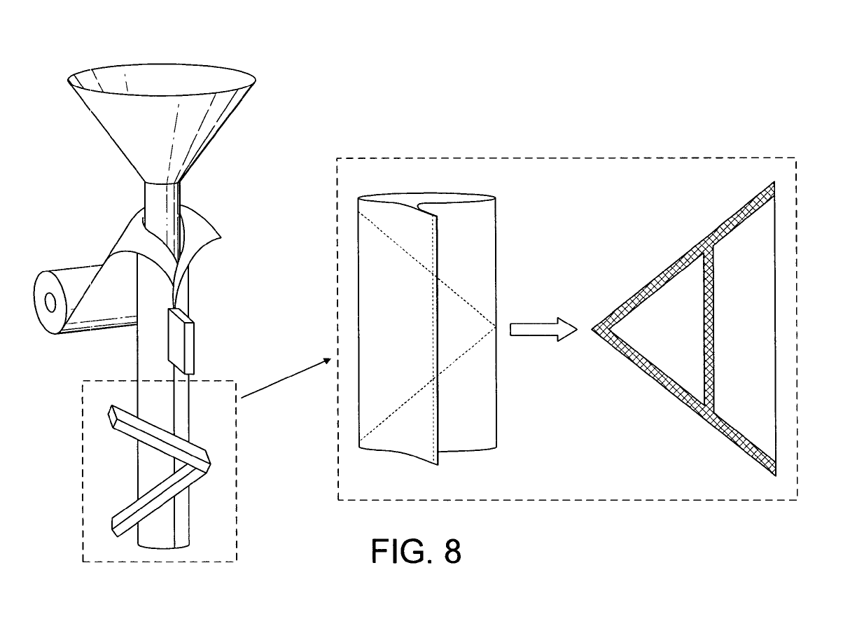

A still further method for producing a sachet and chain of sachets according to the invention is illustrated in FIG. 8. In this embodiment a flexible blank sheet is folded along its length around a tube, e.g. a filling tube, and the margins are sealed to form a tubular structure. Triangular sachets may then be formed by flattening the tubular structure and sealing the opposite surfaces at lines inclined at a angle relative to the length of the tubular structure, e.g. at 45 degree angles to form isosceles triangular sachets. During formation of the sachets they may be filled with the substance to be stored therein through the filling tube in a similar manner as described above for other embodiments of the method of the invention.

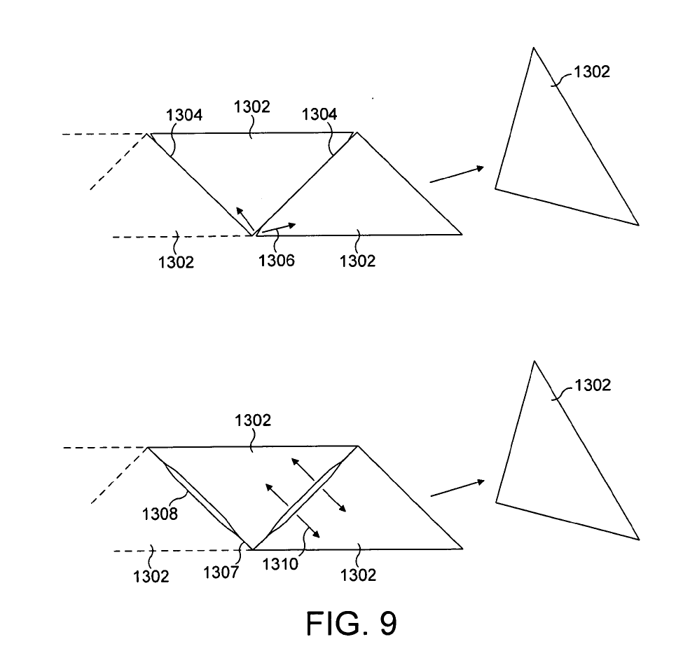

FIG. 9 is a schematic representation of sachets dissociation from a chain of sachets to individual sachets prior to use. Irrespective which method in accordance with the present invention is employed for the manufacture of the chain of sachets, and weather they are provisioned with a weakened area between two subsequent sachets or with an opening between two subsequent sachets, the sachets manufactured in accordance with the present invention offer a user facility of use since they can be easily dissociated from the chain, for sale or direct use purposes.

In the example illustrated in the top part of FIG. 9 a chain of closed right angle isosceles triangle sachets 1302 is a chain of sachets linked together by a single layer of laminate at the area common 1304 between two adjacent sachets. Area 1304 may be further weakened by perforations. In order to dissociate two subsequent sachets 1302 from the chain a user needs to apply pressure along lines 1306 in order to create an initial rip along area 1304. Due to the lower stiffness of area 1304 as compared with surrounding areas, customers will experience an easy separation process.

In the example illustrated in the bottom part of FIG. 9 a chain of closed right angle isosceles triangle sachets 1302 is a chain of sachets linked together by three layers of laminate in an area common between the two subsequent sachets. Said area consists of areas 1306 that links two subsequent sachets at their corner areas and an opening 1308 where the sachets are already dissociated. A user wishing to dissociate from the chain an individual sachet will apply pressure along lines 1310, for example by introducing a finger through said opening.

While performing the sealing of the sachet as described earlier in the present document at least in connection with step 1006, optionally the sealing head may or may not detach from each other the subsequent triangular sachets of the manufactured chain of triangular sachets.

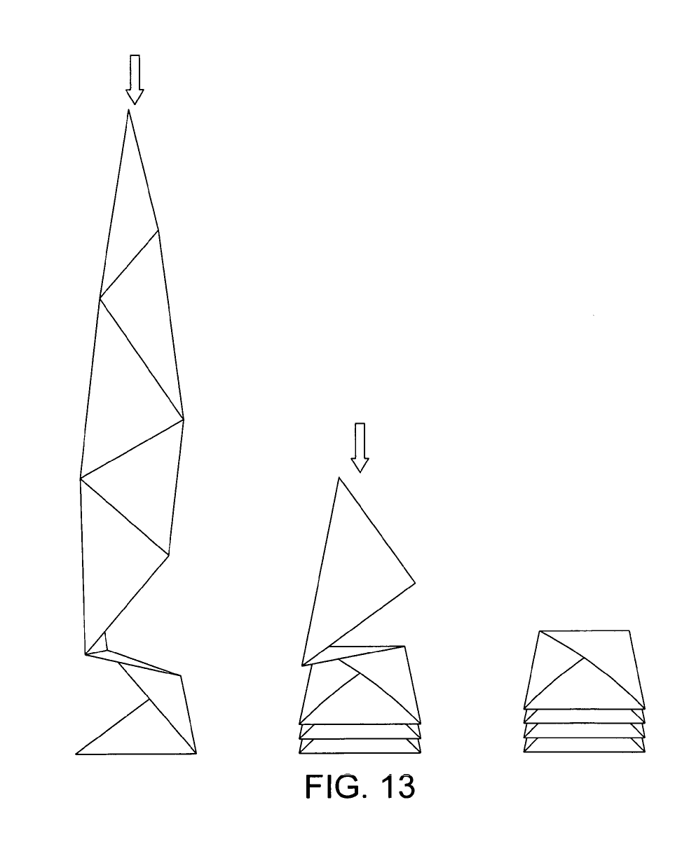

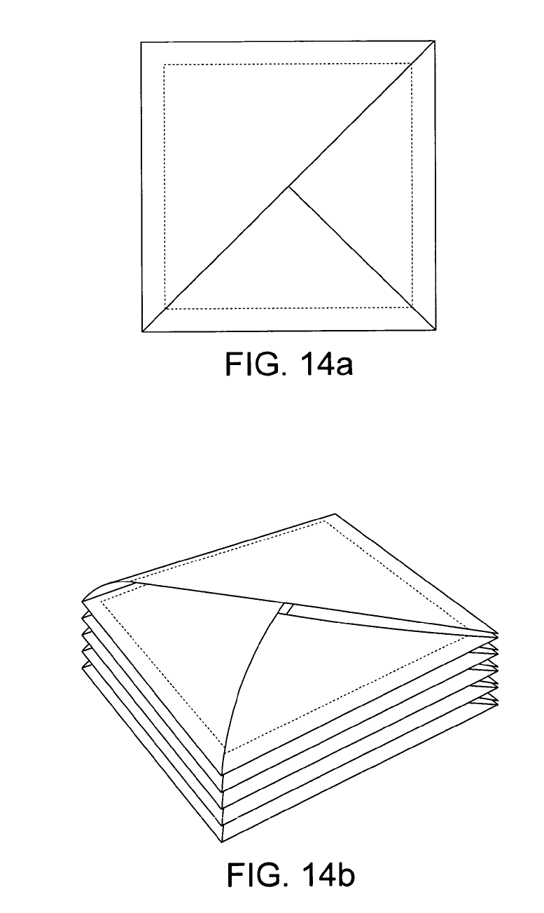

The chain may be folded into a polygonal shape, e.g. in the case of isosceles triangular shaped sachets into a square shape as illustrated in FIGS. 10, 13 and 14 due to the 45 degrees angle of the sealing line to the length axis of the chain. As such, the folded chain will have optimized dimensions for subsequent storage, is easy to pack in secondary packaging and the individual sachets may be easily dispensed from a square box.

Therefore, a method of storage of a chain of closed flexible sachets proposed by the present invention comprises folding upon itself in circular motion the chain of closed flexible sachets, compacting the folded chain of sachets into a polygonal shape. I a further step the compacted sachet chain may be wrapped into a box for presentation or into any other form of outer wrapping or structure for storage. The polygonal shape is preferably a square.

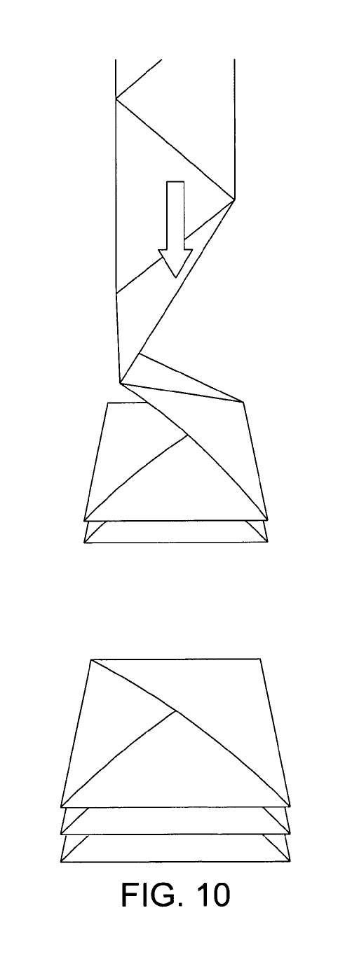

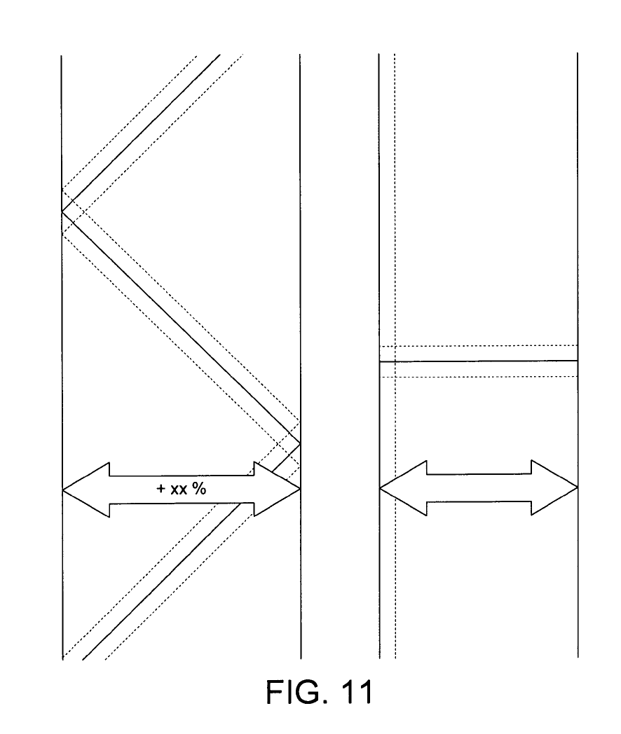

FIG. 11 is a view of a sachet chain of the invention (right) compared to a conventional rectangular sachet (left) on display. As it may be observed from FIG. 11, a chain of triangular closed flexible sachets may be displayed for a user either in a commercial environment or in a storage environment. Said chain of triangular sachets may be presented and displayed with a larger width than a classical chain of rectangular sachets, although allowing at the same time the display of a larger number of individual portion sachets in the same display space due to its optimised use of the display space. Display may be facilitated by a hanger attached to the triangular sachet chain (not shown in the figure).

Therefore a method of displaying a chain of closed flexible sachets in accordance with the present invention comprises at least unfolding the chain of sachets, hanging the chain of sachets, wherein a hanging device may be employed to facilitate hanging, and displaying a chain of flexible sachets.

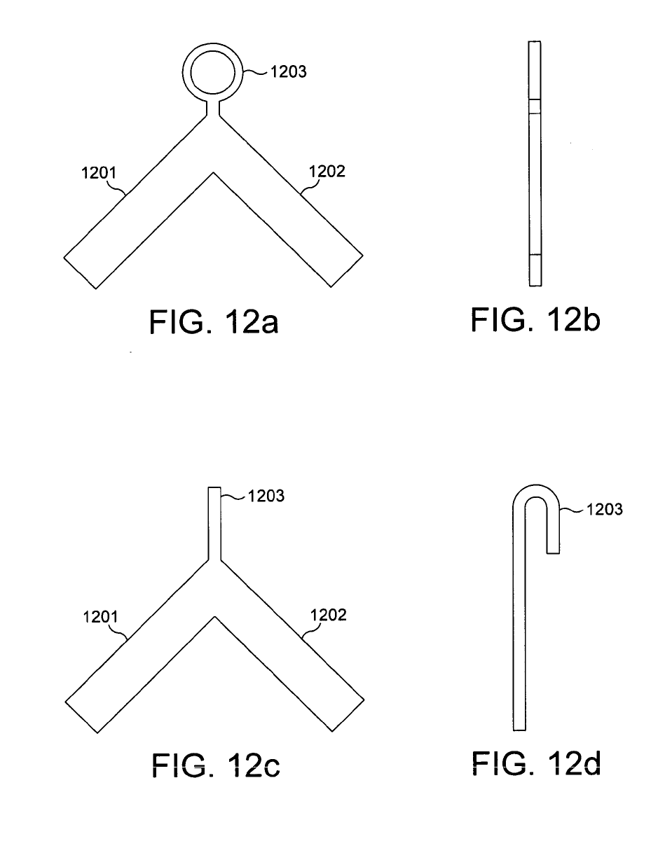

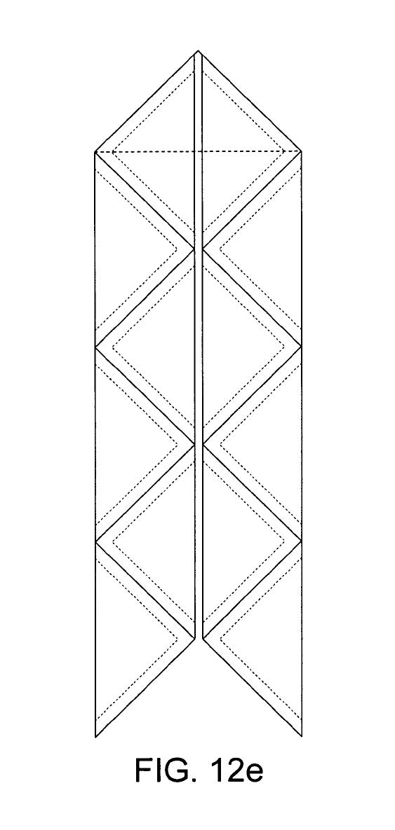

The present invention further relates to a hanging device for storing and/or displaying a chain of sachets of the invention, the hanging device comprising two upwardly facing sides (1201, 1202) at a right angle relative to each other in the vertical plane, and means (1203) for fixing said hanging device to a solid structure. Such a hanging device is illustrated in FIG. 12. A chain of sachets to be stored and/or displayed is folded over the hanging device as illustrated in FIG. 12e, such that all sachets, except for the top sachet, are oriented to have the front sides facing in the same direction. The hanging device can be fixed to any suitable solid structure, e.g. a wall, or a horizontal bar. The means for fixing the hanging device to a solid structure may be any suitable means such as e.g. a hook or a ring. The invention also relates to a kit of parts comprising a hanging device as disclosed above and a chain of sachets according to the invention.

1. A chain of sachets comprising a plurality of individual triangular closed flexible sachets bonded together at either one of an extremity of each individual sachet or along a welding line,
each individual triangular closed flexible sachet comprising:
an interior space enclosed by one sheet of flexible blank material, the sheet of flexible blank material being welded along only two sides of the triangular closed flexible sachet to define the interior space.

2. The chain of sachets of claim 1, wherein each triangular closed flexible sachet has a shape that is a right angle isosceles triangle.

3. The chain of sachets of claim 1, wherein the flexible blank material is impermeable to oxygen and to water vapour.

4. The chain of sachets of claim 1, wherein the flexible blank of material is made of a material selected from the group consisting of aluminum, polyester, polyethylene, polypropylene, polyamide, polystyrene, paper, copolymer of ethylene and vinyl alcohol, polyvinylidene chloride, polyvinylacetate, bioplastic and mixtures thereof.

5. The chain of sachets of claim 1, wherein each interior space comprises an individual portion of a powdered beverage.

6. The chain of sachets of claim 5, wherein the powdered beverage is selected from the group consisting of ground roast coffee, tea, instant coffee, a mixture of instant coffee and ground coffee, a chocolate product, a malted beverage product, dehydrated milk, and dehydrated cream.

7. The chain of sachets of claim 1, wherein each sachet is substantially symmetrical about the sealing line.

8. The chain of sachets of claim 1, wherein each sachet comprises a plurality of split lines located at designated corners of the triangular shape.

9. A method of manufacturing a chain of triangular closed flexible sachet holding a substance comprising:
folding upon itself a flexible sheet to form a triangular interior space;
filling the triangular interior space with the substance; sealing the at least one folded sheet along a plurality of welding lines so as to capture the substance in the interior space; and
repeating the steps above one or more times.

10. The method of manufacturing a chain of triangular closed flexible sachet holding a substance of claim 9, wherein the plurality of welding lines comprises one of two or three welding lines.

11. The method of claim 9 comprising folding the flexible sheet upon itself at a 45 degrees angle relative to the length, to form a right angle triangular shaped interior space;
filling the interior space with the substance; and
sealing the right angle triangular interior space along the two open sides.

12. The method of claim 11 wherein one of the two open sides of the right angle triangular interior space is sealed before filling the interior space with the substance.

13. The method of manufacturing a chain of triangular closed flexible sachet holding a substance of claim 9, wherein the plurality of welding lines comprises at least one of a sealing line along the direction of a filing tube and sealing lines at 45 degree angles versus the direction of the filing tube.

14. The method of claim 9 comprising dissociating the chain of triangular sachets to form a plurality of individual triangular sachets.

15. A method of manufacturing a chain of triangular closed flexible sachet holding a substance, comprising:
rolling a blank sheet of flexible material around itself or around a tube until the margin of the blank is united with the blank itself enclosing a cylindrical volume and creating an overlap of the blank with itself along the margin;
joining the two layers of the blank at the overlap by sealing to create a tubular structure;
dispensing the substance into the tubular structure; and
flattening the tubular structure and joining the already formed sealing to the opposite surface of the flattened tube creating a sealing of three layers enclosing triangular interior spaces enclosing said substance.

16. A method of storage of a chain of closed flexible sachets, comprising:
folding upon itself in circular motion the chain of triangular closed flexible sachets; and
compacting the folded chain of sachets into a polygonal shape.

17. A method of displaying a chain of triangular closed flexible sachets, comprising:
unfolding a chain of flexible closed sachets comprising a plurality of triangle shaped individual sachets; and
hanging the chain of sachets to be displayed.

18. A hanging device for storing and/or displaying a chain of sachets comprising a plurality of individual triangular closed flexible sachets bonded together at either one of an extremity of each individual sachet or along a welding line, each individual triangular closed flexible sachet comprising: an interior space enclosed by one sheet of flexible blank material, the sheet of flexible blank material being welded along only two sides of the triangular closed flexible sachet to define the interior space, the hanging device comprising two upwardly facing sides at a right angle relative to each other in the vertical plane, and a member for fixing the hanging device to a solid structure.

19. (canceled)
